(19) United States
(12) Patent Application Publication
(10) Pub. No.: US 2026/0296084 A1
(43) Pub. Date: Oct. 1, 2026

(54) Method For Producing Transfer Medium And Transfer Recording Method

(71) Applicant: SEIKO EPSON CORPORATION, Tokyo (JP)

(72) Inventors: Takayoshi KAGATA, Shiojiri (JP); Kunihiro FUJITA, Shiojiri (JP); Seiichi MATSUSHIMA, Matsumoto (JP); Yuya NAKAMURA, Shiojiri (JP); Takumi JOKO, Shiojiri (JP)

(21) Appl. No.: 19/629,697

(22) Filed: Mar. 26, 2026

(30) Foreign Application Priority Data
Mar. 27, 2025 (JP) 2025-053160

(51) Int. Cl. B41M 5/50; B41M 5/025; B41M 5/52

(52) U.S. Cl. CPC B41M 5/502; B41M 5/0256; B41M 5/5272; B41M 5/5281

(57) ABSTRACT

A method for producing a transfer medium according to the present disclosure includes forming a first layer by attaching an image forming ink to a transfer sheet and forming a second layer by attaching an adhesive ink to partially overlap the first layer. The image forming ink contains a coloring material and water. The adhesive ink contains resin, a silicone-based surfactant, a solvent having an SP value of 8.0 or more and 14.0 or less, and water. The second layer has a region protruding from the first layer when the transfer sheet is seen in plan view.

The present application is based on, and claims priority from JP Application Serial Number 2025-053160, filed Mar. 27, 2025, the disclosure of which is hereby incorporated by reference herein in its entirety.

### BACKGROUND

### 1. Technical Field

The present disclosure relates to a method for producing a transfer medium and a transfer recording method.

### 2. Related Art

A transfer printing method has been known in which
a transfer medium on which an image is formed is superimposed on a transfer target medium such as a fabric, and the image is transferred to the transfer target medium by application of heat and pressure.

JP-A-2012-245660 discloses a method for producing a transfer medium. The method includes generating color image data representing a color image made up from color dots formed by color ink and generating adhesion image data representing an adhesion image made up from adhesion dots formed by an adhesive liquid. The adhesion dots are arranged so that the adhesive liquid is applied at an amount that corresponds to the amount of the color ink applied per unit area, and the adhesion dots are arranged so that, when the amount of the color ink applied per unit area is zero, the amount of the adhesive liquid applied differs between inside and outside of a region of the adhesion image. More specifically, there is a description that the area of the adhesion image is set to be larger than that of the color image (for example, see paragraphs 0097 to 0100, FIG. 8, and FIG. 20 of JP-A-2012-245660).

However, in a case where the transfer medium is produced using such a method, for example, if the transfer sheet to which the color ink and the adhesive liquid have been applied is tilted, the liquid, that is, the color ink and the adhesive liquid are likely to drip, and thus the image formed using the color ink is likely to be disturbed. When such image disturbance occurs, the image transferred to the transfer target medium has image disturbance such as bleeding.

### SUMMARY

The present disclosure has been made to solve the above problem and can be implemented as the following application example.

A method for producing a transfer medium according to an application example of the present disclosure includes forming a first layer by attaching an image forming ink to a transfer sheet and forming a second layer by attaching an adhesive ink to partially overlap the first layer. The image forming ink contains a coloring material and water. The adhesive ink contains resin, a silicone-based surfactant, a solvent having an SP value of 8.0 or more and 14.0 or less, and water. The second layer has a region protruding from the first layer when the transfer sheet is seen in plan view.

A transfer recording method according to an application example of the present disclosure includes: thermally transferring the first layer and the second layer included in the transfer medium produced by the method for producing a transfer medium according to the application example of the present disclosure onto a transfer target medium.

A transfer recording method according to another application example of the present disclosure includes: forming a first layer by attaching an image forming ink to a transfer sheet; forming a second layer by attaching an adhesive ink to partially overlap the first layer; drying the transfer sheet by heating the transfer sheet on which the first layer and the second layer are formed; and thermally transferring the first layer and the second layer included in the transfer medium produced through the forming the first layer to the drying onto a transfer target medium. The image forming ink contains a coloring material and water. The adhesive ink contains resin, a silicone-based surfactant, a solvent having an SP value of 8.0 or more and 14.0 or less, and water. An amount of the silicone-based surfactant in the adhesive ink is 0.02% by mass or more and 1.50% by mass or less. An amount of the solvent in the adhesive ink is 0.5% by mass or more and 10.0% by mass or less. The second layer has a region protruding from the first layer when the transfer sheet is seen in plan view. The forming the first layer uses, as the image forming ink, a white ink containing the coloring material that is white and a color ink containing the coloring material that has a hue other than white, and forms a white layer by using the white ink on a color layer formed by using the color ink. In the forming the second layer, an ejection amount of the adhesive ink per unit area in the region protruding from the first layer is greater than an ejection amount of the adhesive ink per unit area in a region overlapping the first layer, when the transfer sheet is seen in plan view. An average ejection amount of the image forming ink per unit area of the transfer sheet is 30 g/m² or more and 200 g/m² or less when the transfer sheet is seen in plan view. An average ejection amount of the adhesive ink per unit area of the transfer sheet is 30 g/m² or more and 500 g/m² or less when the transfer sheet is seen in plan view.

### BRIEF DESCRIPTION OF THE DRAWINGS

FIGS. 1A-1C are a process diagram illustrating a method for producing a transfer medium according to a preferred embodiment of the present disclosure.

FIGS. 2A-2C are a process diagram illustrating a transfer recording method according to a preferred embodiment of the present disclosure.

FIG. 3 is a table showing compositions of image forming inks of Preparation Examples A1 to A4.

FIG. 4 is a table showing compositions of adhesive inks of Preparation Examples B1 to B7.

FIG. 5 is a table collectively showing production conditions of transfer media and recorded products of Examples 1 to 8.

FIG. 6 is a table collectively showing production conditions of transfer media and recorded products of Examples 9 to 11 and Comparative Examples 1 to 4.

FIG. 7 is a table collectively showing evaluation results of Examples 1 to 8.

FIG. 8 is a table collectively showing evaluation results of Examples 9 to 11 and Comparative Examples 1 to 4.

### DESCRIPTION OF EMBODIMENTS

Hereinafter, preferred embodiments of the present disclosure will be described in detail.

### 1 Method for Producing Transfer Medium

First, a method for producing a transfer medium of the present disclosure will be described.

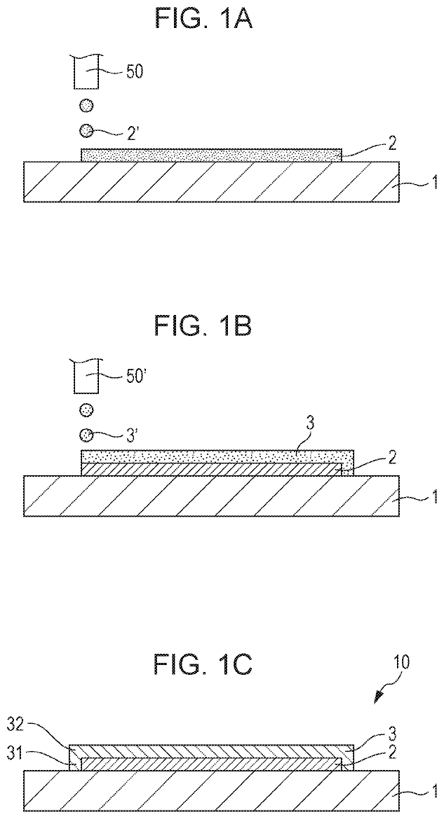

FIGS. 1A-C are a process diagram illustrating a method for producing a transfer medium according to a preferred embodiment of the present disclosure.

The method for producing a transfer medium 10 illustrated in FIGS. 1A-1C includes a first layer formation step (1A) of forming a first layer 2 by attaching an image forming ink 2′ to a transfer sheet 1 and a second layer formation step (1B) of forming a second layer 3 by attaching an adhesive ink 3′ to partially overlap the first layer 2. The image forming ink 2′ contains a coloring material and water, and the adhesive ink 3′ contains resin, a silicone-based surfactant, a solvent having an SP value of 8.0 or more and 14.0 or less, and water. When the transfer sheet 1 is seen in plan view, the second layer 3 has a region protruding from the first layer 2. With this configuration, ink dripping is unlikely to occur when the transfer sheet 1 to which the image forming ink 2′ and the adhesive ink 3′ have been applied is transported or tilted and problems such as bleeding and insufficient color developability are unlikely to occur in an image formed by transfer to the transfer target medium 5, and thus this can provide a method for producing the transfer medium 10 that is capable of appropriately producing a transfer medium that can appropriately transfer an image to the transfer target medium 5. This configuration can also effectively reduce cracking or the like in a coating film, which may be caused when the first layer 2 and the second layer 3 are dried.

Furthermore, in a case where a fabric is used as the transfer target medium 5 in the transfer recording method described below, this configuration can effectively reduce the possibility that a produced recorded product 100 will undergo a whitening phenomenon after being washed.

In contrast, a configuration that does not satisfy the above conditions cannot have satisfactory results. For example, when the layer formed using the adhesive ink does not have a region protruding from the layer formed using the image forming ink in plan view of the transfer sheet, ink dripping is likely to occur, for example, when the transfer sheet to which the image forming ink and the adhesive ink have been applied is transported or tilted. As a result, problems such as bleeding and insufficient color developability are likely to occur in an image formed by transfer onto a transfer target medium.

In addition, when the adhesive ink does not contain a silicone-based surfactant, the wettability of the adhesive ink to the transfer sheet decreases, resulting in insufficient wet-spreading of the adhesive ink to the transfer sheet. This is likely to cause so-called ink accumulation, and ink dripping is likely to occur when the transfer sheet to which the image forming ink and the adhesive ink have been applied is transported or tilted. As a result, problems such as bleeding and insufficient color developability are likely to occur in an image formed by transfer onto a transfer target medium.

In addition, when the adhesive ink does not contain a solvent having an SP value of 8.0 or more and 14.0 or less, the following problems occur. That is, in a case where the adhesive ink contains a solvent having an excessively small SP value instead of the solvent having an SP value of 8.0 or more and 14.0 or less, the dispersion of the resin in the ink is unstable, causing the aggregation of the resin over time. When the adhesive ink contains a solvent having an excessively large SP value instead of the solvent having an SP value of 8.0 or more and 14.0 or less, the affinity of the adhesive ink for a transfer sheet having high hydrophobicity generally decreases, and the wettability of the adhesive ink to the transfer sheet decreases, resulting in insufficient wet-spreading of the adhesive ink to the transfer sheet. This is likely to cause so-called ink accumulation, and ink dripping is likely to occur when the transfer sheet to which the image forming ink and the adhesive ink have been applied is transported or tilted. As a result, problems such as bleeding and insufficient color developability are likely to occur in an image formed by transfer onto a transfer target medium.

In the present specification, the SP value refers to a solubility parameter, and a value calculated from the values of evaporation energy and molar volume of atoms and atomic groups by Hansen (see Hansen Solubility Parameters: A user's handbook) is used as the SP value.

### 1-1 First Layer Formation Step

The first layer formation step forms the first layer 2 by attaching the image forming ink 2′ to the transfer sheet 1 (1A).

### 1-1-1 Transfer Sheet

The transfer sheet 1 has a function of supporting the first layer 2 and the second layer 3. The transfer sheet 1 may have a uniform composition as a whole, or may have, for example, a substrate and a release layer.

The surface of the transfer sheet 1, particularly the surface on which the first layer 2 and the second layer 3 are formed, is typically formed of a material having relatively high hydrophobicity. This appropriately prevents or reduces a decrease in mechanical strength caused by attachment of the image forming ink 2′ or the adhesive ink 3′. Examples of such a material include a plastic material and a metal material. Examples of the plastic material include polyester such as polyethylene terephthalate and polyolefin such as polyethylene and polypropylene. Among these, polyethylene terephthalate is preferable as the constituent material of the transfer sheet 1. This enables the transfer sheet 1 to have more appropriate flexibility, improving the ease of handling of the transfer sheet 1.

When the transfer sheet 1 has a substrate and a release layer, examples of the constituent material of the release layer include a polyethylene wax-based release agent, a silicone-based release agent, and a fluorine-based release agent. When the transfer sheet 1 has a substrate and a release layer, for example, a material having relatively high hydrophilicity such as paper can also be used as a constituent material of the substrate.

The thickness of the transfer sheet 1 is not particularly limited but is preferably 30 μm or more and 600 μm or less, more preferably 50 μm or more and 400 μm or less, and still more preferably 70 μm or more and 250 μm or less.

### 1-1-2 Image Forming Ink

The image forming ink 2′ is used to form the first layer 2. In the transfer recording method described below, the first layer 2 forms an image to be transferred to the transfer target medium 5.

The image forming ink 2′ contains a coloring material and water.

### 1-1-2-1 Coloring Material

As the coloring material contained in the image forming ink 2′, for example, various pigments and dyes can be used, and one or more of these may be selected and used in combination.

As the pigment, various inorganic pigments and organic pigments can be used.

As the pigment, for example, a self-dispersing pigment may be used. The self-dispersing pigment is a self-dispersing pigment having a hydrophilic group on the pigment surface, and examples of the hydrophilic group include —OM, —COOM, —CO—, —SO₃M, —SO₂M, —SO₂NH₂, —RSO₂M, —PO₃HM, —PO₃M₂, —SO₂NHCOR, —NH₃, and —NR₃. In the formula, M represents a hydrogen atom, an alkali metal, an ammonium, or an organic ammonium, and R represents an alkyl group having 1 or more and 12 or less carbon atoms or a naphthyl group optionally having a substituent. A phenyl group, for example, may be present between the pigment surface and the hydrophilic group.

The self-dispersing pigment can be produced by subjecting the pigment to a physical treatment or a chemical treatment to bond the hydrophilic group to the surface of the pigment. Examples of the physical treatment include a vacuum plasma treatment. Examples of the chemical treatment include a wet oxidation method in which oxidation using an oxidant is performed in water.

The self-dispersing pigment is preferably a surface treated self-dispersing pigment that has been subjected to an oxidation treatment with a hypohalous acid and/or a hypohalite, an oxidation treatment with ozone, or an oxidation treatment with a persulfuric acid and/or a persulfate, from the viewpoint of high color developability. The self-dispersing pigment may be a commercially available product. Preferred examples thereof include Microjet CW1 (available from Orient Chemical Industries, Co., ltd.), CAB-O-JET250C, CAB-O-JET260M, CAB-O-JET270Y, and CAB-O-JET444MP (available from Cabot Corporation).

Examples of the dye include various acid dyes, reactive dyes, disperse dyes, and sublimation dyes.

The amount of the coloring material in the image forming ink 2′ is not particularly limited but is preferably 1.0% by mass or more and 25.0% by mass or less, more preferably 2.0% by mass or more and 20.0% by mass or less, and even more preferably 5.0% by mass or more and 15.0% by mass or less. This enables the first layer 2 formed using the image forming ink 2′ to readily have a sufficient color density, improving the color developability of the recorded product 100 and also improving the storage stability of the image forming ink 2′. This also improves, in a case where the image forming ink 2′ is ejected by an ink jet method, the ejection stability of the image forming ink 2′ using the ink jet method and the recoverability from clogging in the ink jet head 50.

### 1-1-2-2 Liquid Medium

The image forming ink 2′ contains a liquid medium for dissolving or dispersing the coloring material described above. In other words, the liquid medium contained in the image forming ink 2′ has a function of dissolving or dispersing the coloring material described above.

The liquid medium constituting the image forming ink 2′ contains at least water. This can appropriately prevent excessive wet-spreading of the image forming ink 2′ on the surface of the transfer sheet 1, which is typically formed of a material having high hydrophobicity. This also can improve the transferability of the first layer 2 from the transfer sheet 1 to the transfer target medium 5 in the transfer recording method, which is described in detail below.

The percentage of water in the entire liquid medium constituting the image forming ink 2′ is not particularly limited but is preferably 40.0% by mass or more and 90.0% by mass or less, more preferably 50.08 by mass or more and 85.0% by mass or less, and still more preferably 55.0% by mass or more and 80.0% by mass or less.

The liquid medium constituting the image forming ink 2′ may further contain an organic solvent in addition to water. This enables the viscosity and surface tension of the image forming ink 2′ to be appropriately adjusted. Furthermore, this improves the moisture retention of the image forming ink 2′, and in a case where the image forming ink 2′ is ejected by an ink jet method, this can effectively prevent unintentional precipitation of solids from the image forming ink 2′ caused by drying in the ink jet head 50 or the like and can also improve the recoverability from clogging, resulting in improvement of the ejection stability of the image forming ink 2′.

The organic solvent is preferably a water-soluble organic solvent. As the water-soluble organic solvent, an organic solvent having a solubility in water at 25° C. of 10 g/100 g of water or more can be suitably used. In particular, the image forming ink 2′ preferably contains an organic solvent having a boiling point of 280° C. or more. This improves the moisture retention of the image forming ink 2′.

Examples of the organic solvent, particularly the water-soluble organic solvent, contained in the image forming ink 2′ include polyol compounds, glycol ethers, and cyclic amide compounds. One or more of these may be selected and used in combination.

Examples of the polyol compounds include polyol compounds, preferably diol compounds, having 2 or more and 6 or less carbon atoms in the molecule and optionally having one ether bond in the molecule. Specific examples thereof include glycols such as 1,2-pentanediol, glycerin, ethylene glycol, diethylene glycol, triethylene glycol, polyethylene glycol, propylene glycol, dipropylene glycol, tripropylene glycol, polypropylene glycol, polyoxyethylene polyoxypropylene glycol, 1,2-hexanediol, 1,2-heptanediol, 1,3-propanediol, 1,2-butanediol, 1,3-butanediol, 1,4-butanediol, 2,3-butanediol, 2-methyl-3-phenoxy-1,2-propanediol, 3-(3-methylphenoxy)-1,2-propanediol, 3-hexyloxy-1,2-propanediol, 2-hydroxymethyl-2-phenoxymethyl-1,3-propanediol, 3-methyl-1,3-butanediol, 1,5-pentanediol, 1,6-hexanediol, 2-methyl-2,4-pentanediol, and 3-methyl-1,5-pentanediol. Examples of the glycol ethers include monoalkyl ethers of glycol selected from ethylene glycol, diethylene glycol, triethylene glycol, polyethylene glycol, propylene glycol, dipropylene glycol, tripropylene glycol, polypropylene glycol, and polyoxyethylene polyoxypropylene glycol. Examples of the monoalkyl ethers include triethylene glycol monomethyl ether, triethylene glycol monobutyl ether, triethylene glycol monoethyl ether, and dipropylene glycol monopropyl ether. Examples of the cyclic amide compound include 2-pyrrolidone, N-methyl-2-pyrrolidone, N-hydroxyethyl-2-pyrrolidone, 1,3-dimethylimidazolidinone, 2-piperidone (d-valerolactam), and N-cyclohexyl-2-pyrrolidone.

The percentage of the organic solvent in the entire liquid medium constituting the image forming ink 2′ is not particularly limited but is preferably 10.0% by mass or more and 60.0% by mass or less, more preferably 15.0% by mass or more and 50.0% by mass or less, and still more preferably 20.0% by mass or more and 45.0% by mass or less. This enables the effect of containing the above-described organic solvent to be more remarkably exhibited.

The amount of the liquid medium in the image forming ink 2′ is not particularly limited but is preferably 55.0% by mass or more and 90.0% by mass or less, more preferably 62.0% by mass or more and 88.0% by mass or less, and still more preferably 68.0% by mass or more and 85.0% by mass or less. This enables the first layer 2 formed using the image forming ink 2′ to readily have a sufficient color density, improving the color developability of the recorded product 100 and also improving the storage stability of the image forming ink 2′. This also improves, in a case where the image forming ink 2′ is ejected by an ink jet method, the ejection stability of the image forming ink 2′ using the ink jet method and the recoverability from clogging in the ink jet head 50.

### 1-1-2-3 Resin

The image forming ink 2′ may contain resin. This can improve, for example, the strength of the first layer 2 formed by using the image forming ink 2′ and the adhesion of the first layer 2 to the second layer 3. This also can improve, if the image forming ink 2′ contains a pigment, the dispersion stability of the pigment in the image forming ink 2′.

The amount of the resin in the image forming ink 2′ is preferably 2.0% by mass or more and 15.0% by mass or less, more preferably 4.0% by mass or more and 13.0% by mass or less, and still more preferably 7.0% by mass or more and 12.0% by mass or less. This can improve adhesion of a recording section 4 described below to the transfer target medium 5 while allowing the ejection stability of the image forming ink 2′ using the ink jet method and the production stability of the recorded product 100 using the transfer recording method described below to be sufficiently high. Furthermore, in a case where the transfer target medium 5 is a fabric or the like, this can improve the texture of the recorded product 100.

In a case where the image forming ink 2′ contains resin, the resin may be present in the image forming ink 2′ in any form. For example, in the image forming ink 2′, the resin may be contained in a dispersed state or in a dissolved state but is preferably contained in a dispersed state. This can improve the ejection stability of the image forming ink 2′ using an ink jet method, resulting in more stable formation of the recorded product 100.

In a case where the resin is contained in the image forming ink 2′ in a dispersed state, an average particle size of the resin is preferably 30 nm or more and 3 μm or less, more preferably 50 nm or more and 1 μm or less, and even more preferably 60 nm or more and 300 nm or less.

This enables the above-described effects to be more significantly exhibited.

In this specification, the average particle size refers to a volume-based average particle size and can be determined, for example, by adding a sample to methanol, dispersing the sample with an ultrasonic disperser for 3 minutes, and measuring the dispersion liquid with a Coulter counter particle size distribution analyzer (Model TA-II available from Coulter Electronics, Inc.) using a 50 μm aperture.

Examples of the resin contained in the image forming ink 2′ include polyurethane, polyester, styrene acrylic resin, acrylic resin, and polyvinyl chloride, and one or more of these may be selected and used in combination. Among these, polyurethane is preferable. This enables the above-described effects to be more significantly exhibited.

A glass transition temperature of the resin contained in the image forming ink 2′ is preferably −40° C. or more and 0° C. or less, more preferably −35° C. or more and −5° C. or less, and even more preferably −30° C. or more and −10° C. or less. This can improve the texture, the washing fastness, and the like of the produced recorded product 100, for example, in a case where a fabric is used as the transfer target medium 5 in the transfer recording method described below.

When the image forming ink 2′ contains resin and a pigment, preferably 0.2≤XR/XP≤1.8 is satisfied, more preferably 0.6≤XR/XP≤1.5 is satisfied, and still more preferably 0.8<XR/XP≤1.2 is satisfied, where XR (% by mass) represents the amount of the resin in the image forming ink 2′ and XP (% by mass) represents the amount of the pigment in the image forming ink 2′. This enables the first layer 2 formed using the image forming ink 2′ to readily have a sufficient color density, improving the color developability of the recorded product 100 produced by using the transfer recording method described below, and also improving the storage stability of the image forming ink 2′. This also improves, in a case where the image forming ink 2′ is ejected by an ink jet method, the ejection stability of the image forming ink 2′ using the ink jet method and the recoverability from clogging in the ink jet head 50. Furthermore, in a case where the transfer target medium 5 is a fabric or the like, this can improve the texture of the recorded product 100.

### 1-1-2-4 Surfactant

The image forming ink 2′ may contain a surfactant. As the surfactant, for example, various surfactants such as an anionic surfactant, a cationic surfactant, and a nonionic surfactant can be used.

When the image forming ink 2′ contains a surfactant, the amount of the surfactant in the image forming ink 2′ is preferably 0.02% by mass or more and 1.50% by mass or less, more preferably 0.05% by mass or more and 1.00% by mass or less, and even more preferably 0.07% by mass or more and 0.70% by mass or less.

### 1-1-2-5 Other Components

The image forming ink 2′ may contain components other than the above-described components. Hereinafter, such components will also be referred to as “other components” in this section. Examples of other components include chelating agents, preservatives, antifungal agents, rust inhibitors, flame retardants, various dispersants, pH adjusting agents such as triethanolamine, antioxidants, ultraviolet absorbers, oxygen absorbers, dissolution aids, and penetrants.

Examples of the chelating agents include ethylenediaminetetraacetate. Examples of the preservatives and antifungal agents include sodium benzoate, sodium pentachlorophenol, sodium 2-pyridinthiol-1-oxide, sodium sorbate, sodium dehydroacetate, 1,2-dibenzoisothiazolin-3-one, and 4-chloro-3-methylphenol. Examples of the rust inhibitors include benzotriazole. As the preservatives and the antifungal agents, for example, a compound having an isothiazoline ring structure in the molecule can be suitably used.

The amount of the other components in the image forming ink 2′ is preferably 6.0% by mass or less, and more preferably 5.0% by mass or less. The lower limit of the amount of the other components is 0% by mass.

### 1-1-2-6 Other Conditions

The first layer 2 is formed by applying the image forming ink 2′ to the transfer sheet 1. More specifically, the image forming ink 2′ is applied so as to be in contact with the transfer sheet 1. In this step, the first layer 2 is formed as a reverse image, that is, a mirror image of the recording section 4 to be formed on the transfer target medium 5.

The first layer formation step only needs to use at least one type of the image forming ink 2′ but may use multiple types of the image forming ink 2′. More specifically, as the image forming ink 2′, for example, two or more selected from the group consisting of white ink, black ink, cyan ink, magenta ink, and yellow ink may be used in combination. In addition, for example, even within the same color family, multiple inks having different color densities may be used.

In particular, the step preferably uses a white ink containing a white coloring material and a color ink containing a coloring material that has a hue other than white as the image forming ink 2′ and forms a white layer by using the white ink on a color layer formed by using the color ink. In other words, the first layer 2 is preferably a laminate including a color layer 2A facing the transfer sheet 1 and a white layer 2B provided on the opposite side of the color layer 2A from the surface facing the transfer sheet 1. This configuration can improve the color developability of the recording section 4 of the recorded product 100 produced by the transfer recording method described in detail below. In addition, in a case where the white ink is attached onto the color ink so as to overlap with each other on the transfer sheet, and then the white ink and the color ink are transferred onto the transfer target medium, in general, the attached amount of the entire image forming ink or the total attached amount of the image forming ink and the adhesive ink tends to increase, and thus the above-described problems were likely to occur in the related art. However, the present disclosure can have the above-described effect, even when the attached amount of ink is increased as above. That is, in the first layer formation step, when the color ink and the white ink are used as the image forming ink 2′ and the white ink is attached to overlap the color ink in at least a portion of the transfer sheet 1, the effect of the present disclosure as described above is more remarkably exhibited.

In the present specification, the “color ink” refers to an image forming ink containing a coloring material that has a hue other than white and is a concept that includes not only an ink containing a chromatic coloring material but also an ink not containing a chromatic coloring material but containing a black coloring material. The color layer refers to a layer containing a coloring material having a hue other than white and is a concept that includes not only a layer containing a chromatic coloring material but also a layer not containing a chromatic coloring material but containing a black coloring material. Furthermore, the boundary between the color layer and the white layer formed in this step may be indistinct at least in a portion. In addition, in this step, multiple types of color inks may be used, or multiple types of white inks may be used. Furthermore, not only in the formation of the white layer, but also in the formation of the color layer, the white ink may be used together with the color ink.

The method for applying the image forming ink 2′ to the transfer sheet 1 is not particularly limited, and for example, various printing methods can be used, but an ink jet method is preferable. This can provide advantages, such as more appropriate fine pattern formation and excellent on-demand properties.

Examples of the ink jet method include an on-demand method such as a charge deflection method, a continuous method, a piezoelectric method, and a bubble jet (registered trademark) method. In particular, the piezoelectric method, which ejects an ink from an ink jet head having a piezoelectric oscillator, is preferably employed. This can effectively reduce unintentional denaturation or the like of the constituent components of the image forming ink 2′ in the ink jet head 50 and improve the ejection stability of the ink jet method.

In addition, examples of the ink jet head 50 include a line head that records using a line method and a serial head that records using a serial method. In the line method using a line head, for example, the ink jet head 50 having a width equal to or larger than the recording width of the transfer sheet 1 is fixed to the recording apparatus. Then, the transfer sheet 1 is moved in the sub-scanning direction (the transport direction of the transfer sheet 1), and ink drops of the image forming ink 2′ are ejected from the nozzles of the ink jet head 50 in conjunction with this movement, forming the first layer 2 on the transfer sheet 1. In the serial method using a serial head, for example, the ink jet head 50 is mounted on a carriage movable in the width direction of the transfer sheet 1. Then, the carriage is moved in the main scanning direction (width direction of the transfer sheet 1), and ink droplets of the image forming ink 2′ are ejected from the nozzles of the serial head, which is the ink jet head 50, in conjunction with this movement, forming the first layer 2 on the transfer sheet 1.

The average ejection amount of the image forming ink 2′ to the transfer sheet 1 per unit area is preferably 30 g/m² or more and 200 g/m² or less, more preferably 35 g/m² or more and 150 g/m² or less, and still more preferably 40 g/m² or more and 100 g/m² or less. This enables the first layer 2 formed using the image forming ink 2′ to readily have a sufficient color density while sufficiently reducing the likelihood of problems such as ink dripping and image bleeding, improving the color developability of the recorded product 100. When multiple types of ink are used as the image forming ink 2′, the average of the sum of the ejection amounts of these inks is adopted as the average ejection amount of the image forming ink 2′.

The viscosity of the image forming ink 2′ at 25° C. is preferably 2 mPa·s or more and 10 mPa·s or less, and more preferably 3 mPa·s or more and 8 mPa·s or less. This also improves, for example, in a case where the image forming ink 2′ is ejected by an ink jet method, the ejection stability of the image forming ink 2′ using the ink jet method and the recoverability from clogging in the ink jet head 50. The viscosity can be measured by using a vibrational viscometer, a rotational viscometer, a capillary viscometer, or a rolling-ball viscometer. For example, with the vibrational viscometer, the viscosity can be obtained by a measurement in accordance with JIS Z8809.

The surface tension at 25° C. of the image forming ink 2′ is not particularly limited but is preferably 20 mN/m or more and 60 mN/m or less, more preferably 25 mN/m or more and 50 mN/m or less, and even more preferably 27 mN/m or more and 40 mN/m or less. This also improves, for example, in a case where the image forming ink 2′ is ejected by an ink jet method, the ejection stability of the image forming ink 2′ using the ink jet method and the recoverability from clogging in the ink jet head 50. The surface tension can be measured by the Wilhelmy method or the ring method. The surface tension can be measured using a surface tensiometer (such as DY-300, DY-500, and DY-700 available from Kyowa Interface Science Co., Ltd).

### 1-2 Second Layer Formation Step

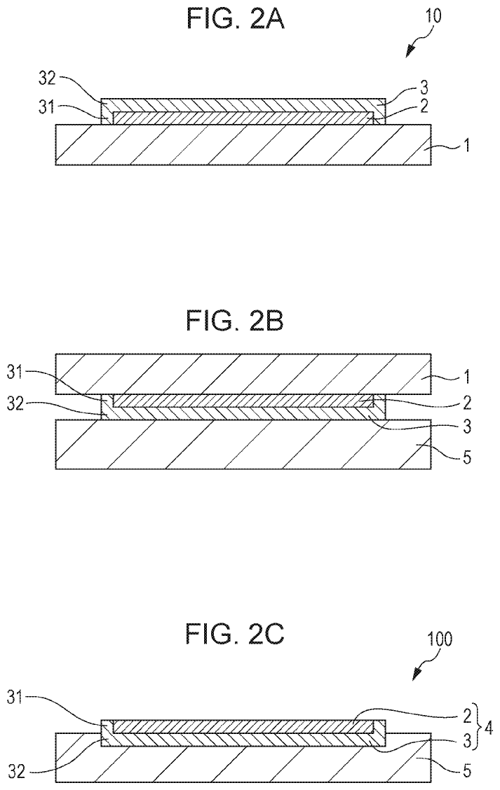

The second layer formation step includes forming the second layer 3 by attaching the adhesive ink 3′ to partially overlap the first layer 2 (1B). In this case, the second layer 3 is formed to have a region protruding from the first layer 2 in plan view of the transfer sheet 1. In other words, the adhesive ink 3′ is applied to a region of the transfer sheet 1 that has the first layer 2 and is also applied to a region of the transfer sheet 1 that does not have the first layer 2. Thus, as illustrated in FIGS. 2A-2C, the second layer 3 formed in this way has an overlapping region 31, which is a region overlapping the first layer 2, and a protruding region 32, which does not overlap the first layer 2 and protrudes from the first layer 2 when the transfer sheet 1 is seen in plan view.

### 1-2-1 Adhesive Ink

The adhesive ink 3′ is used to form the second layer 3 and exhibits adhesiveness in a dry state.

The adhesive ink 3′ contains resin, a silicone-based surfactant, a solvent having an SP value of 8.0 or more and 14.0 or less, and water. This enables, for example, in a case where the adhesive ink 3′ is ejected by an ink jet method, more appropriate ejection of the adhesive ink 3′ using the ink jet method and can improve the adhesion of the recording section 4 to the transfer target medium 5. Furthermore, in a case where the transfer target medium 5 is a fabric or the like, this can improve the washing fastness and the like of the produced recorded product 100.

Furthermore, the wettability of the adhesive ink 3′ to the transfer sheet 1 can be made sufficiently high, and the adhesive ink 3′ can be appropriately wet-spread on the transfer sheet 1, and thus, even when the transfer sheet 1 to which the image forming ink and the adhesive ink 3′ have been applied is transported or tilted, the occurrence of ink dripping can be appropriately prevented, and problems such as bleeding and insufficient color developability in the image formed by transfer to the transfer target medium 5 can be appropriately prevented.

### 1-2-1-1 Resin

The adhesive ink 3′ contains resin. This can improve the adhesion of the recording section 4 to the transfer target medium 5. Furthermore, in a case where the transfer target medium 5 is a fabric or the like, this can improve the washing fastness and the like of the produced recorded product 100.

Examples of the resin contained in the adhesive ink 3′ include polyester, polyurethane, polyvinyl chloride, styrene-acrylic resin, and acrylic resin. One or more of these may be selected and used in combination. However, the resin is preferably one or more selected from the group consisting of polyester, polyurethane, and polyvinyl chloride. This enables the produced recorded product 100 to have both a higher level of texture and a higher level of washing fastness, for example, in a case where a fabric is used as the transfer target medium 5 in the transfer recording method described below.

The resin may be present in the adhesive ink 3′ in any form. For example, in the adhesive ink 3′, the resin may be contained, for example, in a dispersed state or in a dissolved state but is preferably contained in a dispersed state. This can improve, for example, in a case where the adhesive ink 3′ is ejected by an ink jet method, the ejection stability of the adhesive ink 3′ using the ink jet method and the recoverability from clogging in the ink jet head 50′, resulting in more stable formation of the transfer medium 10 and the recorded product 100. This can also effectively prevent the liquid component from undesirably remaining in the second layer 3 or the recording section 4.

When the resin is contained in a dispersed state in the adhesive ink 3′, the average particle size of the resin is preferably 30 nm or more and 3 μm or less, more preferably 50 nm or more and 1 μm or less, and still more preferably 60 nm or more and 300 nm or less. This enables the above-described effects to be more significantly exhibited.

The glass transition temperature of the resin contained in the adhesive ink 3′ is preferably −20° C. or more and 50° C. or less, more preferably −10° C. or more and 45° C. or less, and still more preferably 0° C. or more and 40° C. or less. This can improve, for example, the storage stability of the adhesive ink 3′. Furthermore, for example, in a case where the transfer target medium 5 is a fabric or the like, this enables the recorded product 100 to have both a higher level of texture and a higher level of washing fastness.

The melting point of the resin contained in the adhesive ink 3′ is preferably 80° C. or more and 140° C. or less, more preferably 85° C. or more and 130° C. or less, and still more preferably 90° C. or more and 120° C. or less. This can improve the storage stability of the adhesive ink 3′. Furthermore, in a case where the transfer target medium 5 is a fabric or the like, this enables the recorded product 100 to have both a higher level of texture and a higher level of washing fastness.

The amount of resin in the adhesive ink 3′ is preferably 5.0% by mass or more and 20.0% by mass or less, more preferably 6.0% by mass or more and 17.0% by mass or less, and still more preferably 7.08 by mass or more and 15.0% by mass or less. This can improve, for example, the storage stability of the adhesive ink 3′. Furthermore, for example, in a case where the transfer target medium 5 is a fabric or the like, this enables the recorded product 100 to have both a higher level of texture and a higher level of washing fastness.

### 1-2-1-2 Water

The adhesive ink 3′ contains water. Water is a component that functions as, for example, a dispersion medium for dispersing the resin or a solvent for dissolving the resin in the adhesive ink 3′.

The amount of water in the adhesive ink 3′ is preferably 50.0% by mass or more and 85.0% by mass or less, more preferably 55.0% by mass or more and 80.0% by mass or less, and still more preferably 60.0% by mass or more and 75.0% by mass or less.

### 1-2-1-3 Specific Solvent

The adhesive ink 3′ contains a solvent having an SP value of 8.0 or more and 14.0 or less. Hereinafter, such a solvent is also referred to as a “specific solvent”. When the adhesive ink 3′ contains the specific solvent having relatively high hydrophobicity as described above, the wettability of the adhesive ink 3′ to the transfer sheet 1 can be made sufficiently high, and the adhesive ink 3′ can be appropriately wet-spread on the transfer sheet 1. Thus, even when the transfer sheet 1 to which the image forming ink 2′ and the adhesive ink 3′ have been applied is transported or tilted, the occurrence of ink dripping can be appropriately prevented, and problems such as bleeding and insufficient color developability in the image formed by transfer to the transfer target medium 5 can be appropriately prevented.

The adhesive ink 3′ may contain two or more solvent components as the specific solvent. In this case, all of these solvent components satisfy the condition for the SP value as described above.

The specific solvent preferably contains a solvent component having an SP value of 10.0 or more and 13.7 or less, more preferably contains a solvent component having an SP value of 10.5 or more and 13.0 or less, and still more preferably contains a solvent component having an SP value of 11.0 or more and 12.5 or less. In addition, in a case where the adhesive ink 3′ contains two or more solvent components as the specific solvent, it is preferable that the arithmetic mean of the SP values on a mass basis of the solvent components be within such a range. When these conditions are satisfied, the effect as described above is more remarkably exhibited.

The specific solvent may be any solvent that has the SP value satisfying the conditions described above, and examples of the specific solvent include various polyol compounds, glycol ethers, and cyclic amide compounds, and one or more of these may be selected and used in combination. Examples of the polyol compounds include polyol compounds, preferably diol compounds, having 2 or more and 6 or less carbon atoms in the molecule and optionally having one ether bond in the molecule. Specific examples of the specific solvent include glycols such as 1,2-pentanediol, diethylene glycol, triethylene glycol, polyethylene glycol, dipropylene glycol, tripropylene glycol, polypropylene glycol, polyoxyethylene polyoxypropylene glycol, 1,2-hexanediol, 1,2-heptanediol, 1,2-butanediol, 1,3-butanediol, 2,3-butanediol, 2-methyl-3-phenoxy-1,2-propanediol, 3-(3-methylphenoxy)-1,2-propanediol, 3-hexyloxy-1,2-propanediol, 2-methyl-4-ethyl-1,3-propanediol, 2-hydroxymethyl-2-phenoxymethyl-1,3-propanediol, 3-methyl-1,3-butanediol, 1,5-pentanediol, 1,6-hexanediol, 2-methyl-2,4-pentanediol, and 3-methyl-1,5-pentanediol. Examples of the glycol ethers include monoalkyl ethers of glycols selected from diethylene glycol, triethylene glycol, polyethylene glycol, dipropylene glycol, tripropylene glycol, polypropylene glycol, and polyoxyethylene polyoxypropylene glycol. Examples of the monoalkyl ethers include triethylene glycol monomethyl ether, triethylene glycol monobutyl ether, triethylene glycol monoethyl ether, and dipropylene glycol monopropyl ether. Examples of the cyclic amide compound include 2-pyrrolidone, N-methyl-2-pyrrolidone, N-hydroxyethyl-2-pyrrolidone, 1,3-dimethylimidazolidinone, 2-piperidone (δ-valerolactam), and N-cyclohexyl-2-pyrrolidone.

The amount of the specific solvent in the adhesive ink 3′ is preferably 0.5% by mass or more and 10.0% by mass or less, more preferably 1.0% by mass or more and 7.0% by mass or less, and still more preferably 2.0% by mass or more and 5.0% by mass or less. This enables the above-described effects to be more significantly exhibited. This also enables the viscosity and the surface tension of the adhesive ink 3′ to be more appropriately adjusted. This also can improve the moisture retention of the adhesive ink 3′, and in a case where the adhesive ink 3′ is ejected by an ink jet method, this can effectively prevent unintentional precipitation of solids from the adhesive ink 3′ caused by drying in the ink jet head 50′ or the like and can also improve the recoverability from clogging, resulting in improvement of the ejection stability of the adhesive ink 3′.

### 1-2-1-4 Silicone-Based Surfactant

The adhesive ink 3′ contains a silicone-based surfactant. When the adhesive ink 3′ contains a silicone-based surfactant, the wettability of the adhesive ink 3′ to the transfer sheet 1 can be made sufficiently high, and the adhesive ink 3′ can be appropriately wet-spread on the transfer sheet 1. Thus, even when the transfer sheet 1 to which the image forming ink 2′ and the adhesive ink 3′ have been applied is transported or tilted, the occurrence of ink dripping can be appropriately prevented, and problems such as bleeding and insufficient color developability in the image formed by transfer to the transfer target medium 5 can be appropriately prevented.

The silicone-based surfactant is not particularly limited, and examples thereof preferably include a polysiloxane-based compound. The polysiloxane-based compound is not particularly limited, and examples thereof include a polyether-modified organosiloxane. Examples of commercially available products of the polyether-modified organosiloxane include BYK-306, BYK-307, BYK-3331, BYK-333, BYK-341, BYK-345, BYK-346, BYK-348, BYK-349, BYK-3420, BYK-3450, BYK-3451, BYK-3456, BYK-3480, BYK-3481, BYK-3760 (product names, available from BYK Japan KK), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (product names, available from Shin-Etsu Chemical Co., Ltd.), SAG002, SAG003, SAG005, SAG008, SAG016, SAG020, SAG502, and SAG503A (all product names, available from Nissin Chemical Industry Co., Ltd.), TEGO WET 240, TEGO WET 260, TEGO WET 280, TEGO WET KL245, TEGO TWIN 4000, TEGO TWIN 4100, and TEGO TWIN 4200 (all product names, available from Evonik Japan Co., Ltd.), DOWSIL 67, DOWSIL 500W, DOWSIL 501W, and DOWSIL 502W (product names, available from Dow Toray Co., Ltd.).

The amount of the silicone-based surfactant in the adhesive ink 3′ is preferably 0.02% by mass or more and 1.50% by mass or less, more preferably 0.05% by mass or more and 1.00% by mass or less, and still more preferably 0.10% by mass or more and 0.70% by mass or less. This enables the above-described effects to be more significantly exhibited.

1-2-1-5 Solvent Other than Specific Solvent

The adhesive ink 3′ may further contain a solvent other than the specific solvent in addition to the specific solvent described above. This enables, for example, the viscosity and the surface tension of the adhesive ink 3′ to be more appropriately adjusted. Hereinafter, the solvent other than the specific solvent is also referred to as “other solvent”.

As the other solvent, a water-soluble organic solvent is preferably used. As the water-soluble organic solvent, an organic solvent having a solubility in water at 25° C. of 10 g/100 g of water or more can be suitably used. Examples of the other solvent contained in the adhesive ink 3′ include polyol compounds, glycol ethers, and cyclic amide compounds, and one or more of these may be selected and used in combination. Specific examples of the other solvent include glycols such as glycerin, ethylene glycol, propylene glycol, and 1,4-butanediol. Examples of the glycol ether include monoalkyl ethers of glycols selected from ethylene glycol and propylene glycol.

However, the adhesive ink 3′ preferably does not contain an organic solvent having a boiling point of 280° C. or more. This improves the drying properties of the second layer 3 formed using the adhesive ink 3′, improving the releasability of the laminate including the first layer 2 and the second layer 3 from the transfer sheet 1.

In particular, the adhesive ink 3′ preferably contains propylene glycol as the other solvent. This improves the drying properties and facilitates curing of the resin upon heating, improving the fastness. In particular, when the adhesive ink 3′ contains propylene glycol, the percentage of propylene glycol in the adhesive ink 3′ is preferably 5.0% by mass or more and 25.0% by mass or less, more preferably 7.0% by mass or more and 23.0% by mass or less, and still more preferably 10.0% by mass or more and 20.0% by mass or less. This enables the above-described effects to be more significantly exhibited.

In addition, preferably 0.05≤XS/XPG≤0.70 is satisfied, more preferably 0.07≤XS/XPG≤0.60 is satisfied, and more preferably 0.10≤XS/XPG≤0.40 is satisfied, where XS (% by mass) represents the amount of the specific solvent in the adhesive ink 3′, and XPG (% by mass) represents the amount of propylene glycol in the adhesive ink 3′. This enables the above-described effects to be more significantly exhibited.

### 1-2-1-6 Other Components

The adhesive ink 3′ may contain components other than the above-described components. Hereinafter, such components will also be referred to as “other components” in this section. Examples of other components include surfactants other than the silicone-based surfactant, chelating agents, preservatives, antifungal agents, rust inhibitors, flame retardants, various dispersants, pH adjusting agents such as triethanolamine, antioxidants, antioxidants, ultraviolet absorbers, oxygen absorbers, dissolution aids, and penetrants.

The amount of the other components in the adhesive ink 3′ is preferably 6.0% by mass or less, and more preferably 5.0% by mass or less. The lower limit of the amount of the other components is 0% by mass.

### 1-2-1-7 Other Conditions

The second layer 3 is formed by applying the adhesive ink 3′ to the transfer sheet 1 having the first layer 2. More specifically, the adhesive ink 3′ is applied such that the adhesive ink 3′ partially overlaps and is in contact with the first layer 2 formed in the first layer formation step and partially does not overlap the first layer 2.

In this step, multiple types of adhesive ink 3′ may be used. For example, the adhesive inks 3′ having different types of resin or different amounts of resin may be used.

This step only needs to attach the adhesive ink 3′ to the transfer sheet 1 having the first layer 2 so that the second layer 3 having a region protruding from the first layer 2 in plan view of the transfer sheet 1 is formed, but the adhesive ink 3′ is preferably attached so that 50% or more of the entire length of the edge portion of the first layer 2 is covered by the second layer 3 in plan view of the transfer sheet 1. This enables the above-described effects to be more significantly exhibited. In particular, the proportion of the entire length of the edge portion of the first layer 2 covered by the second layer 3 is more preferably 80% or more, still more preferably 90% or more, and most preferably 100%. This enables the above-described effects to be further significantly exhibited.

The method for applying the adhesive ink 3′ to the transfer sheet 1 having the first layer 2 is not particularly limited, and for example, various printing methods can be used, but an ink jet method is preferable. This can provide advantages, such as more appropriate fine pattern formation and excellent on-demand properties.

Examples of the ink jet method include an on-demand method such as a charge deflection method, a continuous method, a piezoelectric method, and a bubble jet (registered trademark) method. In particular, the piezoelectric method, which ejects an ink from an ink jet head having a piezoelectric oscillator, is preferably employed. This more effectively prevents unintentional denaturation or the like of the constituent components of the adhesive ink 3′ in the ink jet head 50′ and can improve the ejection stability of the ink jet method. In addition, examples of the ink jet head 50′ include a line head, which records using a line method, and a serial head, which records using a serial method.

The average ejection amount of the adhesive ink 3′ to the transfer sheet 1 per unit area is preferably 30 g/m² or more and 500 g/m² or less, more preferably 35 g/m² or more and 300 g/m² or less, and even more preferably 40 g/m² or more and 200 g/m² or less. This can improve the transferability to the transfer target medium 5 while sufficiently reducing the problems such as ink dripping and image bleeding. When multiple types of inks are used as the adhesive ink 3′, the average of the sum of the ejection amounts of the inks is adopted as the average ejection amount of the adhesive ink 3′.

The ejection amount of the adhesive ink 3′ to the transfer sheet 1 per unit area may be the same or different for different portions. For example, the second layer 3 may be formed such that the ejection amount of the adhesive ink 3′ per unit area in the region protruding from the first layer 2 is greater than the ejection amount of the adhesive ink 3′ per unit area in the region overlapping the first layer 2 when the transfer sheet 1 is seen in plan view. In other words, the average ejection amount of the adhesive ink 3′ to the transfer sheet 1 per unit area in the protruding region 32 may be greater than the average ejection amount of the adhesive ink 3′ to the transfer sheet 1 per unit area in the overlapping region 31. This can increase the thickness of the protruding region 32, which is a region near the edge portion in which thickening due to drying easily progresses, compared to the overlapping region 31. This can more appropriately prevent or reduce ink dripping from the inside of the second layer 3.

In this case, the average ejection amount of the adhesive ink 3′ to the transfer sheet 1 per unit area in the overlapping region 31 is preferably 30 g/m² or more and 500 g/m² or less, more preferably 35 g/m² or more and 300 g/m² or less, and even more preferably 50 g/m² or more and 180 g/m² or less. In addition, the average ejection amount of the adhesive ink 3′ to the transfer sheet 1 per unit area in the protruding region 32 is preferably 30 g/m² or more and 700 g/m² or less, more preferably 35 g/m² or more and 500 g/m² or less, and even more preferably 50 g/m² or more and 200 g/m² or less.

The sum of the average ejection amount of the image forming ink 2′ and the average ejection amount of the adhesive ink 3′ to the transfer sheet 1 per unit area is preferably 115 g/m² or more and 700 g/m² or less, and more preferably 120 g/m² or more and 200 g/m² or less. This can improve the transferability to the transfer target medium 5 while sufficiently reducing the problems such as ink dripping and image bleeding. This also enables the first layer 2 formed using the image forming ink 2′ to readily have a sufficient color density, improving the color developability of the recorded product 100.

The viscosity of the adhesive ink 3′ at 25° C. is preferably 2 mPa·s or more and 10 mPa·s or less, and more preferably 3 mPa·s or more and 8 mPa·s or less. This also improves, for example, in a case where the adhesive ink 3′ is ejected by an ink jet method, the ejection stability of the adhesive ink 3′ using the ink jet method and the recoverability from clogging in the ink jet head 50′.

The surface tension of the adhesive ink 3′ at 25° C. is not particularly limited but is preferably 20 mN/m or more and 60 mN/m or less, more preferably 25 mN/m or more and 50 mN/m or less, and even more preferably 27 mN/m or more and 40 mN/m or less. This also improves, for example, in a case where the adhesive ink 3′ is ejected by an ink jet method, the ejection stability of the adhesive ink 3′ using the ink jet method and the recoverability from clogging in the ink jet head 50′.

### 1-3 Drying Step

The method for producing a transfer medium only needs to include the first layer formation step and the second layer formation step described above, but preferably further includes a drying step of drying the transfer sheet 1 having the first layer 2 and the second layer 3 by heating. This can more effectively reduce the above-described problems, such as ink dripping and image bleeding.

The heating temperature of the transfer sheet 1 having the first layer 2 and the second layer 3 in the drying step is not particularly limited but is preferably 100° C. or more, more preferably 120° C. or more and 200° C. or less, and still more preferably 140° C. or more and 180° C. or less. This can improve the productivity of the transfer medium 10 and the recorded product 100 while effectively reducing the above-described problems, such as bleeding of the image.

The heating duration (heating duration at 100° C. or more) in this step is preferably 10 seconds or more and 10 minutes or less, more preferably 1 minute or more and 8 minutes or less, and still more preferably 3 minutes or more and 6 minutes or less.

The transfer medium 10 is produced in the above way (1C).

### 2 Transfer Recording Method

Next, a transfer recording method of the present disclosure will be described.

FIGS. 2A-2C are a process diagram illustrating a transfer recording method according to a preferred embodiment of the present disclosure.

The transfer recording method illustrated in FIGS. 2A-2C include a transfer medium preparation step (2A) of preparing the transfer medium 10 produced by the method for producing a transfer medium described above and a thermal transfer step (2B) of thermally transferring the second layer 3 and the first layer 2 included in the transfer medium 10 to the transfer target medium 5 by heating the transfer medium 10 with the surface having the first layer 2 and the second layer 3 facing the transfer target medium 5. More specifically, the first layer 2 and the second layer 3 included in the transfer medium 10 produced by using the method described in the above section 1 are thermally transferred onto the transfer target medium 5. This can provide a transfer recording method that is unlikely to have problems such as bleeding and insufficient color developability of the image (the recording section 4) formed by transfer to the transfer target medium 5 and that can appropriately transfer the image to the transfer target medium 5. Furthermore, in the related art, in a case where the transfer target medium is a fabric, unintended unevenness is generated in the recording section when the recorded product is washed, causing irregular reflection of light, and the transferred image becomes whitish, but the above-described thermal transfer method can appropriately prevent the occurrence of such a problem.

### 2-1 Transfer Medium Preparation Step

The transfer medium preparation step includes preparing the transfer medium 10 produced by the above-described method for producing a transfer medium (2A). The transfer medium 10 prepared in this step may be obtained by subjecting the transfer medium 10 produced by the above-described method for producing a transfer medium to a process such as cutting into an appropriate size, for example.

### 2-2 Thermal Transfer Step

The thermal transfer step includes thermally transferring the second layer 3 and the first layer 2, which are included in the transfer medium 10, to the transfer target medium 5 by heating the transfer medium 10 with the surface having the first layer 2 and the second layer 3 facing the transfer target medium 5 (2B).

### 2-2-1 Transfer Target Medium

The transfer target medium 5 may be any member but is preferably an absorbent member. This can more effectively prevent the above-described problems such as ink dripping and image bleeding, as compared with the case in which a non-absorbent member is used.

In this specification, the absorbent member refers to a member that absorbs more than 10 mL/m² of water for the period from the first contact to 30 msec^{1/2} in accordance with the Bristow method. The Bristow method is the most widely used method for measuring the amount of liquid absorbed in a short period of time and has been adopted by Technical Association of the Pulp and Paper Industry (JAPAN TAPPI). The test method is detailed in Specification No. 51 “Paper and Cardboards-Liquid Absorption Test Methods-Bristow Method” (in Japanese) in “JAPAN TAPPI Pulp and Paper Test Methods 2000” (in Japanese).

Examples of the absorbent member include various types of paper, porous metals, porous ceramics, porous glass, porous plastics, fabrics, and leather. Among them, fabrics are preferably employed. In the transfer recording on a fabric, the recorded product may be required to have a soft texture and washing fastness peculiar to fabric. The transfer recording method of the present disclosure can be particularly appropriately used for transfer recording on a fabric because a recorded product excellent in texture and washing fastness can be produced, for example, by employing the above-described preferred embodiment.

### 2-2-2 Heating Condition

The heating temperature in this step is not particularly limited but is preferably 120° C. or more and 270° C. or less, more preferably 140° C. or more and 250° C. or less, and still more preferably 150° C. or more and 210° C. or less. Thus, the second layer 3 and the first layer 2, which are included in the transfer medium 10, can be more appropriately thermally transferred to the transfer target medium 5, and the constituent materials of them can be more properly prevented from undesirably remaining on the transfer sheet 1. This can also improve the productivity of the recorded product 100 while saving energy.

Preferably 70≤Tp-Tg≤290 is satisfied, more preferably 95≤Tp-Tg≤260 is satisfied, and still more preferably 110≤Tp-Tg≤210 is satisfied, where Tg (° C.) represents the glass-transition temperature of the resin contained in the adhesive ink 3′ and Tp (° C.) represents the heating temperature in the thermal transfer step. Thus, the second layer 3 and the first layer 2, which are included in the transfer medium 10, can be more appropriately thermally transferred to the transfer target medium 5, and the constituent materials of them can be more properly prevented from undesirably remaining on the transfer sheet 1. This can also improve the productivity of the recorded product 100 while saving energy.

Heating time in the present step is not particularly limited but is preferably 5 seconds or more and 90 seconds or less, more preferably 15 seconds or more and 70 seconds or less, and even more preferably 20 seconds or more and 60 seconds or less. Thus, the second layer 3 and the first layer 2, which are included in the transfer medium 10, can be more appropriately thermally transferred to the transfer target medium 5, and the constituent materials of them can be more properly prevented from undesirably remaining on the transfer sheet 1. This can also improve the productivity of the recorded product 100 while saving energy.

This step may be performed by any method as long as the transfer medium 10 is heated with the surface having the first layer 2 and the second layer 3 facing the transfer target medium 5 but is preferably performed by hot pressing.

When this step is performed by hot pressing, the pressure applied to the laminate of the transfer medium 10 and the transfer target medium 5 is preferably 0.1 N/cm² or more and 30 N/cm² or less, more preferably 0.6 N/cm² or more and 15 N/cm² or less, and still more preferably 1.5 N/cm² or more and 5 N/cm² or less.

### 2-3 Recorded Product

The recorded product 100 (2C) is produced after the above steps.

The recorded product 100 produced as described above has the recording section 4 formed of the second layer 3 and the first layer 2.

When the transfer target medium 5 is an absorbent member, at least a portion of the recording section 4 is preferably disposed in the transfer target medium 5. This can improve the durability and the like of the recorded product 100.

### 2-4 Summary

As described above, the transfer recording method according to the present disclosure only needs to thermally transfer the first layer 2 and the second layer 3 included in the transfer medium 10 produced by the method including: forming a first layer 2 by attaching an image forming ink 2′ to a transfer sheet 1; and forming a second layer 3 by attaching an adhesive ink 3′ to partially overlap the first layer 2, onto a transfer target medium 5, wherein the image forming ink 2′ contains a coloring material and water, the adhesive ink 3′ contains resin, a silicone-based surfactant, a solvent having an SP value of 8.0 or more and 14.0 or less, and water, and the second layer 3 has a region protruding from the first layer 2 when the transfer sheet 1 is seen in plan view. The method is preferably a method including: forming a first layer 2 by attaching an image forming ink 2′ to a transfer sheet 1; forming a second layer 3 by attaching an adhesive ink 3′ to partially overlap the first layer 2; drying the transfer sheet 1 by heating the transfer sheet 1 on which the first layer 2 and the second layer 3 are formed; and thermally transferring the first layer 2 and the second layer 3 included in the transfer medium 10 produced through the forming the first layer to the drying, onto a transfer target medium 5, wherein the image forming ink 2′ contains a coloring material and water, the adhesive ink 3′ contains resin, a silicone-based surfactant, a solvent having an SP value of 8.0 or more and 14.0 or less, and water, an amount of the silicone-based surfactant in the adhesive 3′ ink is 0.02% by mass or more and 1.50% by mass or less, an amount of the solvent in the adhesive ink 3′ is 0.5% by mass or more and 10.0% by mass or less, the second layer 3 has a region protruding from the first layer 2 when the transfer sheet 1 is seen in plan view, the forming the first layer uses, as the image forming ink 2′, a white ink containing the coloring material that is white and a color ink containing the coloring material that has a hue other than white, and forms a white layer by using the white ink on a color layer formed by using the color ink, in the forming the second layer 3, an ejection amount of the adhesive ink 3′ per unit area in the region protruding from the first layer 2 is greater than an ejection amount of the adhesive ink 3′ per unit area in a region overlapping the first layer 2, when the transfer sheet 1 is seen in plan view, an average ejection amount of the image forming ink 2′ per unit area is 30 g/m² or more and 200 g/m² or less when the transfer sheet 1 is seen in plan view, and an average ejection amount of the adhesive ink 3′ per unit area is 30 g/m² or more and 500 g/m² or less when the transfer sheet 1 is seen in plan view. This enables each of the above-described effects to work synergistically with each other, resulting in a particularly excellent effect.

### 3 Ink Set

Next, the ink set according to the present disclosure will be described.

The ink set according to the present disclosure includes the image forming ink and the adhesive ink described above. More specifically, the ink set according to the present disclosure preferably includes the image forming ink that satisfies the conditions described in above 1-1-2 and the adhesive ink that satisfies the conditions described in above 1-2-1.

The ink set according to the present disclosure only needs to include at least one type of the image forming ink and at least one type of the adhesive ink but may include multiple types of the image forming ink or multiple types of the adhesive ink. Furthermore, the ink set according to the present disclosure may further include another ink in addition to the image forming ink and the adhesive ink that satisfies the above-described conditions.

Although the preferred embodiments of the present disclosure have been described above, the present disclosure should not be limited to the embodiments.

For example, the method for producing a transfer medium according to the present disclosure only needs to include the first layer formation step and the second layer formation step, and the above-described drying step may be omitted. The method for producing a transfer medium according to the present disclosure may further include steps other than the above-described steps, such as a pretreatment step, an intermediate treatment step, and a post-treatment step. The transfer recording method according to the present disclosure only needs to include the thermal transfer step and may further include another step other than the thermal transfer step.

The above mainly explains a case where a method for ejecting ink droplets by an ink jet method is employed as the method for applying the image forming ink and the method for applying the adhesive ink, but the method for applying the image forming ink and the method for applying the adhesive ink are not limited to the ink jet method.

The above mainly explains a case where an absorbent member is used as the transfer target medium, but a non-absorbent member, such as a metal or plastic member that is non-absorbent, may also be used as the transfer target medium.

In the above-described embodiment, after the first layer having a desired pattern is formed on the transfer sheet by attaching the image forming ink, the second layer having a desired pattern is formed by applying the adhesive ink, and then the layers are thermally transferred. However, in the present disclosure, multiple steps may be performed simultaneously. More specifically, for example, the image forming ink and the adhesive ink may be applied simultaneously at different portions of the same transfer sheet.

### EXAMPLES

Next, specific examples of the present disclosure will be described.

### 4 Preparation of Image Forming Ink

### Preparation Example A1

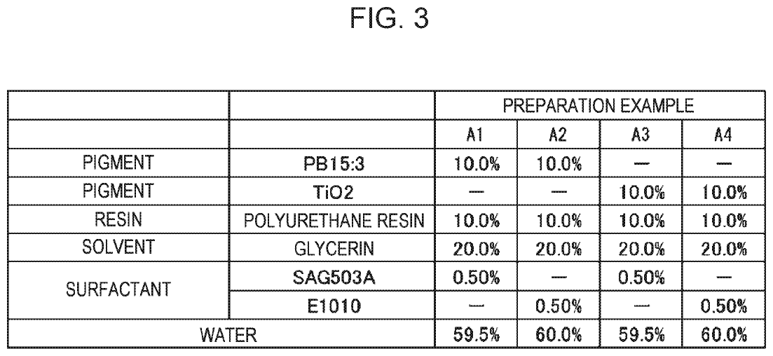

An image forming ink having the composition shown in FIG. 3 was produced by mixing components in a predetermined ratio.

### Preparation Examples A2 to A4

Image forming inks were prepared in the same manner as in Preparation Example A1 except that types of components that form the image forming inks and the ratios of the components were changed as shown in FIG. 3.

FIG. 3 collectively shows the compositions of the image forming inks of Preparation Examples A1 to A4. In FIG. 3, “%” for the percentage content of each component refers to % by mass, “PB15:3” refers to C. I. Pigment Blue 15:3, “TiO2” refers to titanium dioxide used as a white pigment, “polyurethane resin” refers to polyurethane resin having a glass-transition temperature of −20° C. (available from Mitsui Chemicals, Inc., TAKELAC W6110 solid content), “SAG503A” refers to SILFACE SAG503A (available from Nissin Chemical Industry Co., Ltd.) used as a silicone-based surfactant, and “E1010” refers to OLFINE E1010 (available from Nissin Chemical Industry Co., Ltd.) used as acetylene glycol-based surfactant. In addition, in each of Preparation Examples A1 to A4, the average particle size of the resin contained in the image forming ink was 60 nm or more and 300 nm or less. In each of Preparation Examples A1 to A4, the surface tension at 25° C. of the image forming ink was 27 mN/m or more and 40 mN/m or less, and the viscosity at 25° C. of the image forming ink was 3 mPa·s or more and 8 mPa·s or less. The surface tension was measured by the Wilhelmy method using a surface tensiometer (DY-300 available from Kyowa Interface Science Co., Ltd), and the viscosity was measured in accordance with JIS Z8809 using a vibrational viscometer (VM-100 available from SEKONIC CORPORATION).

### 5 Preparation of Adhesive Ink

### Preparation Example B1

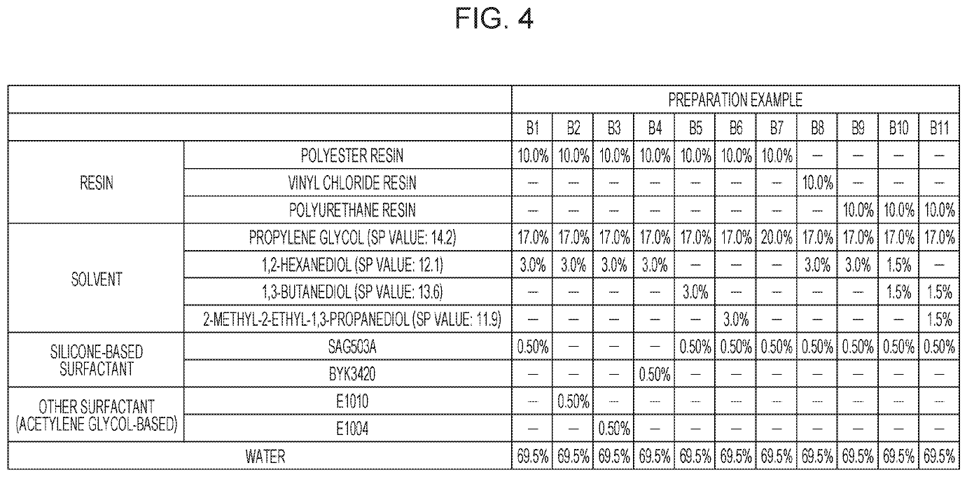

An adhesive ink having the composition shown in FIG. 4 was produced by mixing components in a predetermined ratio.

### Preparation Examples B2 to B7

Adhesive inks were prepared in the same manner as in Preparation Example B1 except that types of components that form the adhesive inks and the ratios of the components were changed as shown in FIG. 4.

FIG. 4 collectively shows the compositions of the adhesive inks of Preparation Examples B1 to B7. In FIG. 4, “%” for the percentage content of each component refers to % by mass, “polyester resin” refers to polyester resin (available from UNITIKA LTD., KT0507 solid content), “vinyl chloride resin” refers to vinyl chloride resin (available from Nissin Chemical Industry Co., Ltd., VINYBLAN 715S solid content), “polyurethane resin” refers to polyurethane resin (available from Mitsui Chemicals, Inc. TAKELAC W6061 solid content), “SAG503A” refers to SILFACE SAG503A (available from Nissin Chemical Industry Co., Ltd.) used as a silicone-based surfactant, “BYK3420” refers to BYK3420 (available from BYK Japan KK) used as a silicone-based surfactant, “E1010” refers to “OLFINE E1010 (available form Nissin Chemical Industry Co., Ltd.) used as an acetylene glycol-based surfactant, and “E1004” refers to OLFINE E1004 (available form Nissin Chemical Industry Co., Ltd.) used as an acetylene glycol-based surfactant. In addition, in each of Preparation Examples B1 to B7, the average particle size of the resin contained in the adhesive ink was 60 nm or more and 300 nm or less. In addition, in each of Preparation Examples B1 to B7, the surface tension at 25° C. of the adhesive ink was 27 mN/m or more and 40 mN/m or less, and the viscosity at 25° C. of the adhesive ink was 3 mPa·s or more and 8 mPa·s or less. The surface tension was measured by the Wilhelmy method using a surface tensiometer (DY-300 available from Kyowa Interface Science Co., Ltd), and the viscosity was measured in accordance with JIS Z8809 using a vibrational viscometer (VM-100 available from SEKONIC CORPORATION).

### 6 Production of Transfer Medium and Recorded Product

### Example 1

First, a transfer sheet (print film for DTF, available from Ink Mania LLC) provided with a release layer formed of a release agent was prepared on a substrate formed of polyethylene terephthalate.

Next, the image forming ink produced in Preparation Example A1, the image forming ink produced in Preparation Example A3, and the adhesive ink produced in Preparation Example B1 were loaded in an ink jet recording apparatus (SC-F2150 available from Seiko Epson).

Next, a first layer having a predetermined pattern was formed by ejecting the image forming ink produced in Preparation Example A1 in a predetermined pattern from the ink jet head to the surface of the transfer medium that has the release layer and further ejecting the image forming ink produced in Preparation Example A3 so that it overlaps the pattern formed by the image forming ink produced in Preparation Example A1 in the same pattern. At this time, the average ejection amount of the image forming ink to the transfer sheet per unit area, that is, the total ejection amount of the image forming ink produced in Preparation Example A1 and the image forming ink produced in Preparation Example A3 was set to be 90 g/m².

Next, the second layer was formed by ejecting the adhesive ink from the ink jet head so that the second layer partially overlaps the first layer in the same pattern. That is, the second layer was formed so as to have an overlapping region, which is a region overlapping the first layer, and a protruding region, which does not overlap the first layer and protrudes from the first layer when the transfer sheet is seen in plan view. At this time, the average ejection amount of the adhesive ink to the transfer sheet per unit area was set to be 60 g/m². That is, in this example, the sum of the average ejection amount of the image forming ink and the average ejection amount of the adhesive ink to the transfer sheet per unit area was 150 g/m². Furthermore, the average ejection amount of the adhesive ink to the transfer sheet per unit area in the overlapping region was set to be 150 g/m², and the average ejection amount of the adhesive ink to the transfer sheet per unit area in the protruding region was set to be 180 g/m².

Next, the transfer sheet having the first layer and the second layer was dried at 160° C. for 5 minutes, and thus a transfer medium was produced.

Next, the transfer sheet was subjected to a heat treatment at 170° C. and hot-pressing at 4.2 N/cm² for 40 seconds with the surface having the first layer and the second layer facing a cotton broadcloth (#4000), which is an absorbent transfer target medium available from Nisshinbo Holdings Inc., to thermally transfer the second layer and the first layer onto the transfer target medium. The transfer medium was then removed, and thus the recorded product was produced.

### Examples 2 to 11 and Comparative Examples 1 to 3

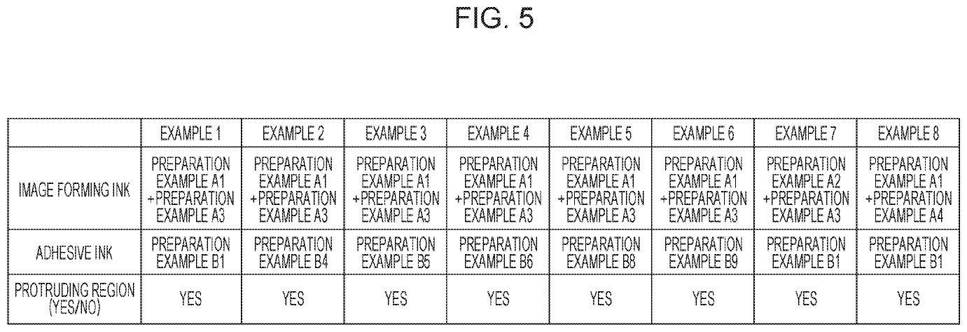

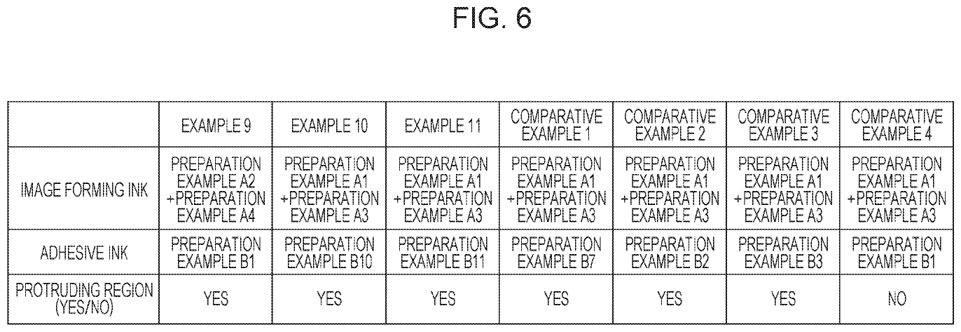

Transfer media and recorded products were produced in the same manner as in Example 1 except that types of the image forming ink and the adhesive ink were changed as shown in FIGS. 5 and 6.

### Comparative Example 4

A transfer medium and a recorded product were produced in the same manner as in Example 1 except that the adhesive ink was not applied to a region protruding from the first layer when the transfer sheet was seen in plan view, and the second layer was formed to have only the overlapping region.

FIG. 5 and FIG. 6 collectively show the production conditions of the transfer media and recorded products of Examples and Comparative Examples.

### 7 Evaluation

### 7-1 Ink Dripping

The transfer media of Examples and Comparative

Examples before drying were each left to stand still with the main surface facing in the vertical direction. After 5 minutes had elapsed, the transfer media were each visually observed and evaluated for ink dripping according to the following criteria. A and B were considered a good level.
A: No ink dripping was observed.
B: Ink dripping was barely observed.
C: Ink dripping was clearly observed.

### 7-2 Bleeding

The recorded products of Examples and Comparative Examples were each evaluated for bleeding as follows.

For evaluation of bleeding, each ink composition was loaded in an ink jet recording apparatus (SC-F2150 available from Seiko Epson), and recording was performed on a recording target medium (Ecofreen premium (available from Ecofreen Co., Ltd.)). More specifically, a filling pattern that can be recorded with a duty of 100% at a resolution of a horizontal 1200 dpi and a vertical 600 dpi was produced and used. The solid patterns in different colors of the recorded product were printed adjacent to each other and dried at 160° C. for 5 minutes, and bleeding at the boundary portion was visually observed for evaluation according to the following evaluation criteria. This evaluation was performed in a laboratory at room temperature (25° C.). A and B were considered a good level.
A: No bleeding at the boundary portion was observed.
B: Some bleeding at the boundary was observed.
C: Considerable bleeding at the boundary was observed.

### 7-3 Cracking in Coating Film

The recorded products of Examples and Comparative Examples were each evaluated for cracking in the coating film as follows.

For evaluation of cracking in the coating film, each ink composition was loaded in an ink jet recording apparatus (SC-F2150 available from Seiko Epson), and recording was performed on a recording medium (Ecofreen premium (available from Ecofreen Co., Ltd.)). More specifically, a filling pattern that can be recorded with a duty of 100% at a resolution of a horizontal 1200 dpi and a vertical 600 dpi was produced and used. The solid patterns in different colors of the recorded product were printed adjacent to each other and dried at 160° C. for 5 minutes, and evaluation was performed for cracking in the coating film according to the following criteria. A and B were considered a good level.
A: No cracking in the coating film was observed.
B: Slight cracking in the coating film was observed.
C: Obvious cracking in the coating film was observed.

### 7-4 Texture

The recorded products of Examples and Comparative Examples were each evaluated for texture as follows.

Specifically, the recorded products were each sensory evaluated for texture by a specific blindfolded evaluator according to the following criteria. A and B were considered a good level.
A: Soft and non-coarse
B: Slightly hard and slightly coarse
C: Very coarse

### 7-5 Washing Fastness

The recorded products of Examples and Comparative Examples were each evaluated for washing fastness as follows.

Specifically, the washing fastness test was carried out in accordance with ISO 105 C10 (B2), and the washing fastness was evaluated according to the following criteria. A and B were considered a good level.
AA: Washing fastness level of 3-4 or higher
A: Washing fastness level of 3 or higher and less than 3-4
B: Washing fastness level of 2 or higher and lower than 3
C: Washing fastness level of lower than 2

### 7-6 Releasability

For each of Examples and Comparative Examples, the transfer medium after transfer of the recording section to the transfer target medium was observed and evaluated for releasability according to the following criteria. A and B were considered a good level.
A: 100% transfer of the image area printed on the transfer medium
B: 80% or more and less than 100% transfer of the image area printed on the transfer medium
C: Less than 80% transfer of the image area printed on the transfer medium

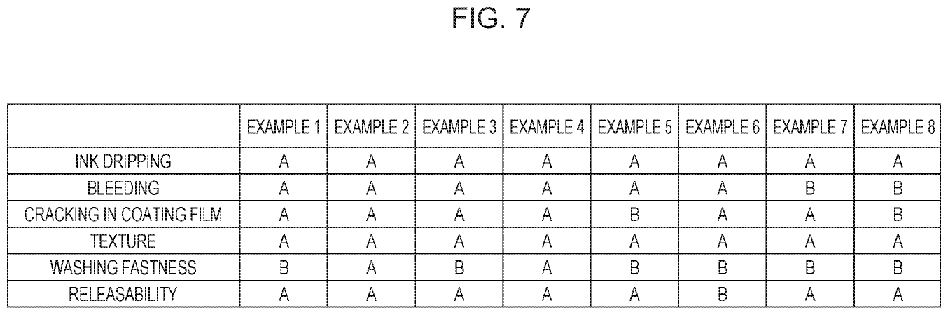

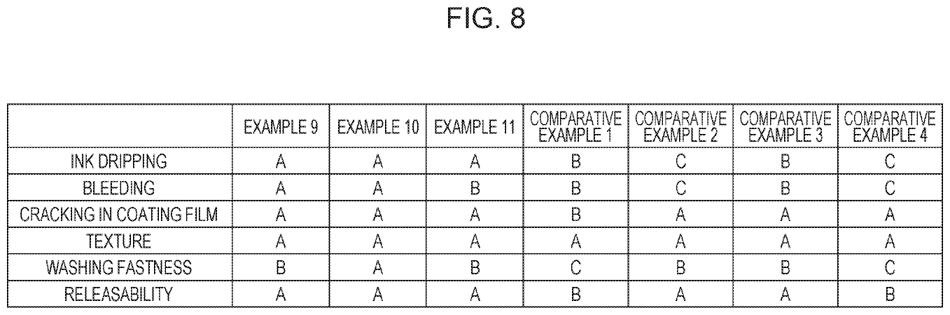

These results are collectively shown in FIGS. 7 and 8.

As is clear from FIGS. 7 and 8, the present disclosure showed excellent results. In contrast, Comparative Examples showed unsatisfactory results.

Additionally, transfer media and recorded products were produced in the same manner as in Examples except that the amount of the silicone-based surfactant in the adhesive ink was varied within the range of 0.02% by mass or more and 1.50% by mass or less, the amount of the solvent in the adhesive ink was varied within the range of 0.5% by mass or more and 10.0% by mass or less, the average ejection amount of the image forming ink to the transfer sheet per unit area was varied within the range of 30 g/m² or more and 200 g/m² or less, the average ejection amount of the adhesive ink to the transfer sheet per unit area was varied within the range of 30 g/m² or more and 500 g/m² or less, the average ejection amount of the adhesive ink to the transfer sheet per unit area in the overlapping region was varied within the range of 30 g/m² or more and 500 g/m² or less, the average ejection amount of the adhesive ink to the transfer sheet per unit area in the protruding region was varied within the range of 30 g/m² or more and 700 g/m² or less, and the sum of the average ejection amounts of the image forming ink and the adhesive ink to the transfer sheet was varied within the range of 115 g/m² or more and 700 g/m² or less. The produced transfer media and recorded products were evaluated in the same manner as above, and the same excellent results were obtained as above.

Additionally, transfer media and recorded products were produced in the same manner as in Examples except that, as the transfer sheets, instead of the print film for DTF available from Ink Mania LLC, Ecofreen Premium Plus (available from Ecofreen Co., Ltd.), DTF Transfer film (available from Kodak), and DTF-FOIL-XCC-60 (Print Equipment GmbH & Co. KG) were used, and as the transfer target media, instead of Cotton Broad (#4000) available from Nisshinbo Holdings Inc., TC4520 (available from TOYOSHIMA & CO., LTD., blend fabric of 35% by mass cotton and 65% by mass polyester fiber), Tropical (available from Toray Industries, Inc., polyester fabric), PAREL Taffeta N2188 (available from Toray Industries, Inc., nylon fabric), natural leather cowhide (available from Daiki Hikaku K.K.), PET50A (available from LINTEC Corporation, PET film), and a 50 μm thick aluminum plate (opened two-piece can) were used. The produced transfer media and recorded products were evaluated in the same manner as above, and the same excellent results were obtained as above.

What is claimed is:

1. A method for producing a transfer medium comprising:
forming a first layer by attaching an image forming ink to a transfer sheet; and
forming a second layer by attaching an adhesive ink to partially overlap the first layer, wherein
the image forming ink contains a coloring material and water,
the adhesive ink contains resin, a silicone-based surfactant, a solvent having an SP value of 8.0 or more and 14.0 or less, and water, and
the second layer has a region protruding from the first layer when the transfer sheet is seen in plan view.

2. The method for producing a transfer medium according to claim 1, wherein the forming the first layer uses, as the image forming ink, a white ink containing the coloring material that is white and a color ink containing the coloring material that has a hue other than white, and forms a white layer by using the white ink on a color layer formed by using the color ink.

3. The method for producing a transfer medium according to claim 1, wherein, in the forming the second layer, an ejection amount of the adhesive ink per unit area in the region protruding from the first layer is greater than an ejection amount of the adhesive ink per unit area in a region overlapping the first layer, when the transfer sheet is seen in plan view.

4. The method for producing a transfer medium according to claim 1, wherein an amount of the silicone-based surfactant in the adhesive ink is 0.02% by mass or more and 1.50% by mass or less.

5. The method for producing a transfer medium according to claim 1, wherein an amount of the solvent in the adhesive ink is 0.5% by mass or more and 10.0% by mass or less.

6. The method for producing a transfer medium according to claim 1, wherein an average ejection amount of the image forming ink to the transfer sheet per unit area is 30 g/m² or more and 200 g/m² or less.

7. The method for producing a transfer medium according to claim 1, wherein an average ejection amount of the adhesive ink to the transfer sheet per unit area is 30 g/m² or more and 500 g/m² or less.

8. The method for producing a transfer medium according to claim 1, further comprising drying the transfer sheet by heating the transfer sheet on which the first layer and the second layer are formed.

9. A transfer recording method comprising thermally transferring the first layer and the second layer included in the transfer medium produced by the method for producing a transfer medium according to claim 1 onto a transfer target medium.

10. A transfer recording method comprising:
forming a first layer by attaching an image forming ink to a transfer sheet;
forming a second layer by attaching an adhesive ink to partially overlap the first layer;
drying the transfer sheet by heating the transfer sheet on which the first layer and the second layer are formed; and
thermally transferring the first layer and the second layer included in the transfer medium produced through the forming the first layer to the drying onto a transfer target medium, wherein
the image forming ink contains a coloring material and water,
the adhesive ink contains resin, a silicone-based surfactant, a solvent having an SP value of 8.0 or more and 14.0 or less, and water,
an amount of the silicone-based surfactant in the adhesive ink is 0.02% by mass or more and 1.50% by mass or less,
an amount of the solvent in the adhesive ink is 0.5% by mass or more and 10.0% by mass or less,
the second layer has a region protruding from the first layer when the transfer sheet is seen in plan view,
the forming the first layer uses, as the image forming ink, a white ink containing the coloring material that is white and a color ink containing the coloring material that has a hue other than white, and forms a white layer by using the white ink on a color layer formed by using the color ink,
in the forming the second layer, an ejection amount of the adhesive ink per unit area in the region protruding from the first layer is greater than an ejection amount of the adhesive ink per unit area in a region overlapping the first layer, when the transfer sheet is seen in plan view,
an average ejection amount of the image forming ink per unit area is 30 g/m² or more and 200 g/m² or less when the transfer sheet is seen in plan view, and
an average ejection amount of the adhesive ink per unit area is 30 g/m² or more and 500 g/m² or less when the transfer sheet is seen in plan view.
